(19) United States
(12) Patent Application Publication
(10) Pub. No.: US 2021/0166167 A1
(43) Pub. Date: Jun. 3, 2021

(54) ARTIFICIAL INTELLIGENCE AND BLOCKCHAIN-BASED INTER-ENTERPRISE CREDIT RATING AND RISK ASSESSMENT METHOD AND SYSTEM

(71) Applicant: ASIA UNIVERSITY, TAICHUNG CITY (TW)

(72) Inventors: YUH JIUN LIN, TAICHUNG CITY (TW); HAN CHAO LEE, TAICHUNG CITY (TW); KO YANG WANG, TAICHUNG CITY (TW)

(21) Appl. No.: 16/700,102

(22) Filed: Dec. 2, 2019

(51) Int. Cl. G06Q 10/06; G06Q 40/02; H04L 9/06

(52) U.S. Cl. CPC G06Q 10/0635; H04L 9/0637; G06Q 10/067; G06Q 40/025

(57) ABSTRACT

An artificial intelligence and blockchain-based inter-enterprise credit rating and risk assessment method and system include: establishing the credit rating-related data of an enterprise under assessment and of an upstream enterprise, downstream enterprise, and competing enterprise of the enterprise under assessment and the business relationship between the aforesaid enterprises in a blockchain and a database respectively, wherein the credit rating-related data at least include goodwill-related performances, financial performances, transaction performances, competition performances, and credit-related performances; and analyzing the data in the blockchain and database with AI to determine the credit rating of the enterprise under assessment, and comparing the credit rating-related data of the current period with those of a previous period by a statistical method so as to establish a risk trend, thereby allowing the current-period variation of the credit rating risk of the enterprise under assessment to be accurately determined on a chronological basis.

### BACKGROUND OF THE INVENTION

### 1. Technical Field

The present invention relates to a financial credit rating and risk assessment method. More particularly, the invention relates to an inter-enterprise credit rating and risk assessment method and system that are based on artificial intelligence (AI) and a blockchain.

### 2. Description of Related Art

Small- and medium-sized enterprises (SMEs) need funds to support their business operations and, when short of funds, may borrow money from financial institutions to fill the funding gap. Generally, an SME of a relatively small scale has less data transparency than a large company with regard to corporate financial activities, sales performances, and so on, and is therefore often faced with such difficulties as banks hesitating to grant the credit applied for and a relatively high financing cost. When rating the credit of a single company, a bank tends to have difficulties identifying an operational crisis attributable to industry-wide factors, which involve not only the upstream and downstream companies, but also the competitors, of the company in question in the supply chain, and failure to identify such crises indicates the inability to identify and track the hidden systematic risks completely and continuously.

To solve the aforesaid problems, the Dun & Bradstreet Corporation of the US proposed “A SYSTEM AND METHOD USING MULTI-DIMENSIONAL RATING TO DETERMINE AN ENTITY'S FUTURE COMMERCIAL. VIABILITY”, for which Taiwan Invention Patent No. 1634508 was granted, and which involve applying a data field-based scoring rule to such multi-dimensional data as business identity, activity signals, payment transactions, and financial statements in order to calculate the viability score and rating of the business under assessment. This credit rating method, however, is applicable to a single enterprise only.

Kunshan LoanFast Information Technology Ltd of China proposed a “MULTI-DIMENSIONAL CONTROL AND PROCESSING METHOD FOR RISK CONTROL”, which was assigned Chinese Published Patent Application No. 108960678, and which carries out enterprise risk control by taking into account such multi-dimensional data as the relationships between a parent company and its subsidiary company or companies, the relationships between upstream and downstream enterprises, and the relationships between regions/countries. This method is designed to control the total financing quota of an enterprise cooperation system but not to assess the risk of business operation of the enterprise.

Other prior arts such as Chinese Published. Patent Application No. 105930981, entitled “RISK QUANTIFICATION AND REAL-TIME AUTOMATIC-PROCESSING SUPPLY CHAIN FINANCE PLATFORM”; Chinese Published Patent Application No. 109191279, entitled “SMALL- AND MEDIUM-SIZED ENTERPRISE CREDIT RISK ASSESSMENT PLATFORM BASED ON ONLINE SUPPLY CHAIN FINANCE”; and Chinese Published Patent Application No. 109214703, entitled “METHOD AND DEVICE FOR ASSESSING FOREIGN TRADE ONE-STOP SERVICE ENTERPRISES” provide financial credit rating or risk assessment methods for use in supply chain finance to determine whether to finance or grant credit to an enterprise or not. The afore-cited methods, however, can be used to assess a single enterprise only but not to assess the risks of an enterprise, of its supply chain, and of the business conditions of the entire related industry as a whole.

### BRIEF SUMMARY OF THE INVENTION

The primary objective of the present invention is to provide an inter-enterprise credit rating and risk assessment method and system that are based on AI and a blockchain. The method and system disclosed herein are intended to reinforce, financial credit rating and risk assessment on SMEs, to identify as many systematic risks as possible, to reduce bad debts, and to safeguard creditors' rights.

To achieve the foregoing objective, the present invention provides an AI and blockchain-based inter-enterprise credit rating and risk assessment method that is carried out as follows:

To start with, the credit rating-related data of an enterprise under assessment, of the upstream and downstream enterprises of the enterprise under assessment, and of the competing enterprises of the enterprise under assessment and the business relationships between the aforesaid enterprises are established in a blockchain and a database respectively. The credit rating-related data at least include but are not limited to goodwill-related performances, financial performances, transaction performances, competition performances, and credit-related performances.

Next, AI and a statistical method are used to analyze and compare data of different periods (e.g., the data of the current period and of a previous period) in order to determine the credit ratings of the enterprise under assessment and the variation, if any, of the risk of the enterprise under assessment on a chronological basis.

More specifically, a positively associated credit rating variation factor for the enterprise under assessment is established according to the data in the blockchain and the database that involve the upstream and downstream enterprises and according to other positive-impact indicator data as well.

Similarly, a negatively associated credit rating variation factor for the enterprise under assessment is established according to the data in the blockchain and the database that involve the competing enterprises and according to other negative-impact indicator data as well.

After that, a risk score of the enterprise under assessment is calculated according to the positively associated credit rating variation factor and the negatively associated credit rating variation factor.

A risk trend curve is then created using the risk scores of the enterprise under assessment that correspond to different periods respectively.

The risk rating of the enterprise under assessment in a certain period is determined by the corresponding slope variation of the risk trend curve.

More specifically, the positively associated credit rating variation factor is used to establish a risk scoring matrix, and the negatively associated credit rating variation factor is used to establish another risk scoring matrix. Each risk scoring matrix defines a plurality of indicator values, and each indicator value is given a positive or negative weight according to the strength of the corresponding positively associated or negatively associated credit rating variation factor. The risk scoring matrices are then used in combination to calculate a combined risk score. The risk trend curve is plotted from the combined risk scores of different periods in a chronological order.

The matrix-based assessment system is so designed that each indicator value can be given a different weight according to the strength of the corresponding positively associated or negatively associated credit rating variation factor, in order to determine the risk score through a weighted calculation.

A system constructed according to the foregoing method includes: a blockchain and database unit for collecting the credit rating-related data of the enterprise under assessment, of the upstream and downstream enterprises of the enterprise under assessment, and of the competing enterprises of the enterprise under assessment; a blockchain and database unit for establishing the business relationships between the enterprise under assessment, the upstream and downstream enterprises, and the competing enterprises; an AI-based credit rating calculation unit for the enterprise under assessment, the upstream and downstream enterprises, and the competing enterprises; and a calculation unit for analyzing the credit and risk of the enterprise under assessment.

### BRIEF DESCRIPTION OF THE SEVERAL VIEWS OF THE DRAWINGS

FIG. 1 is a flowchart of the present invention;

FIG. 2 to FIG. 6 show a process for determining the credit rating of an enterprise under assessment according to the invention; and

FIG. 7 and FIG. 8 show a process for analyzing the risk trend of an enterprise under assessment according to the invention.

### DETAILED DESCRIPTION OF THE INVENTION

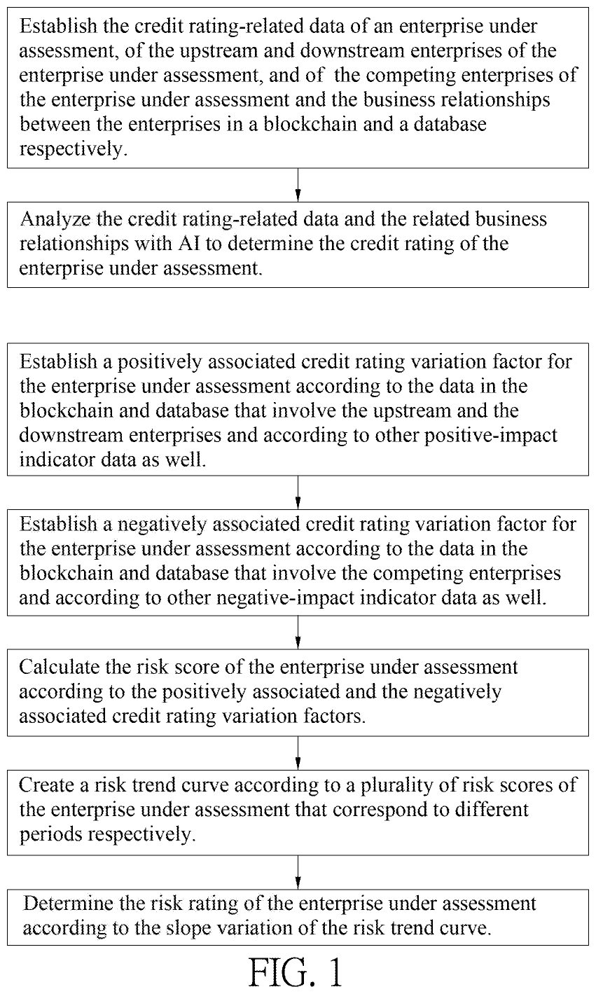

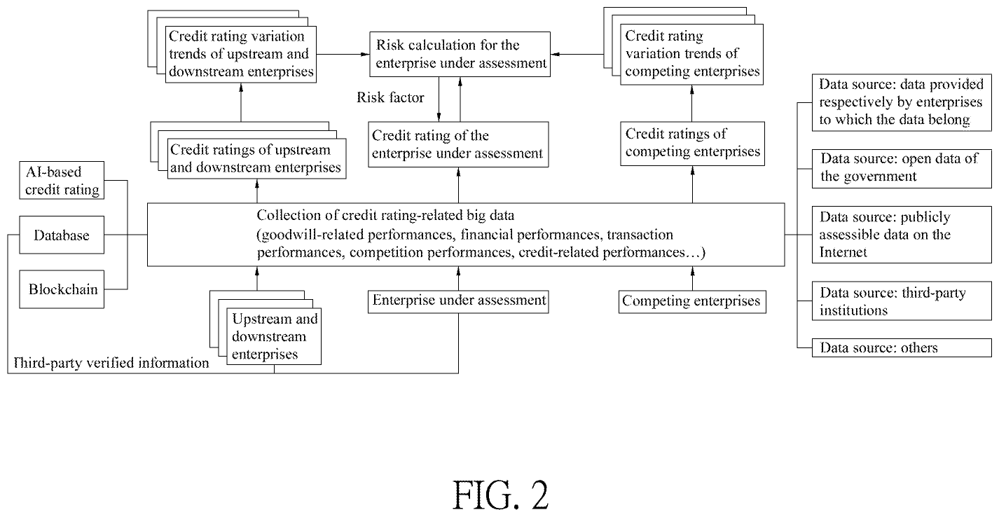

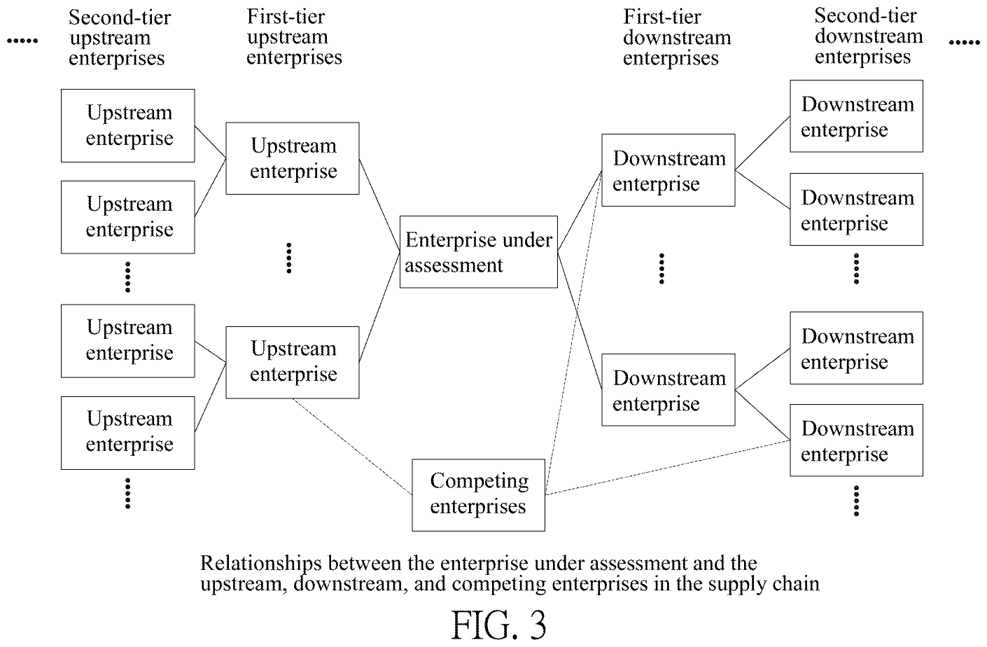

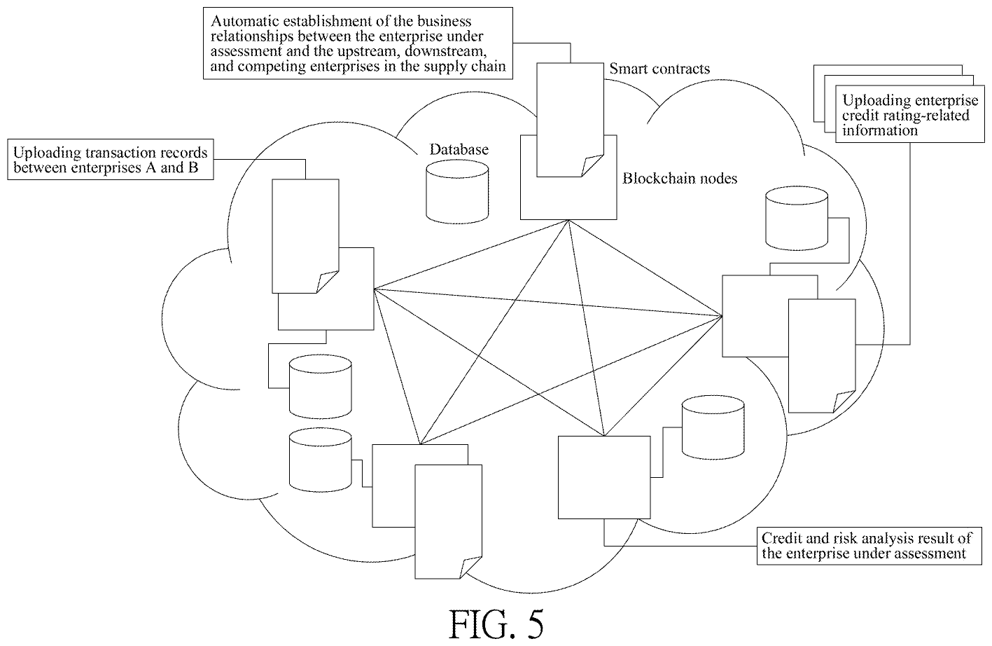

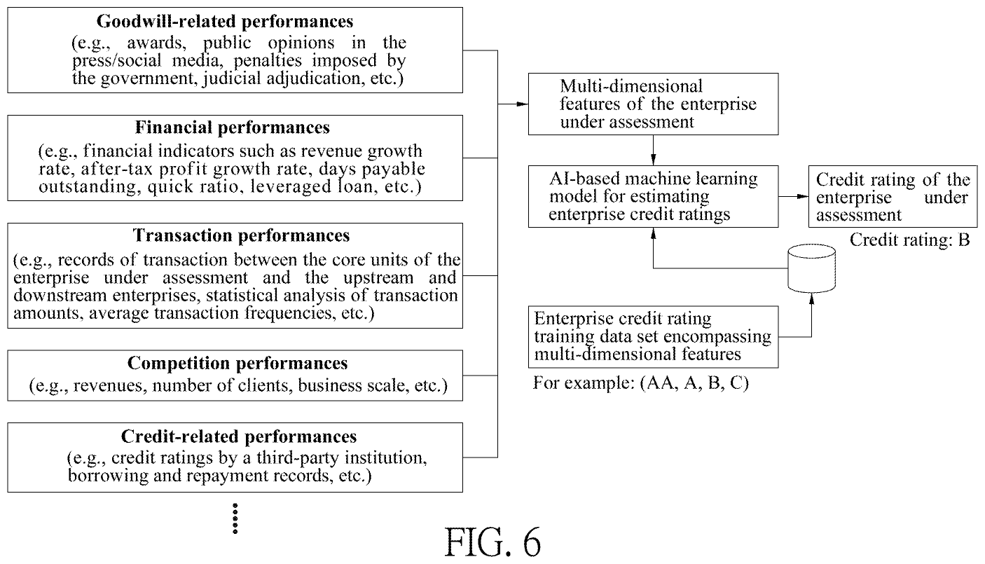

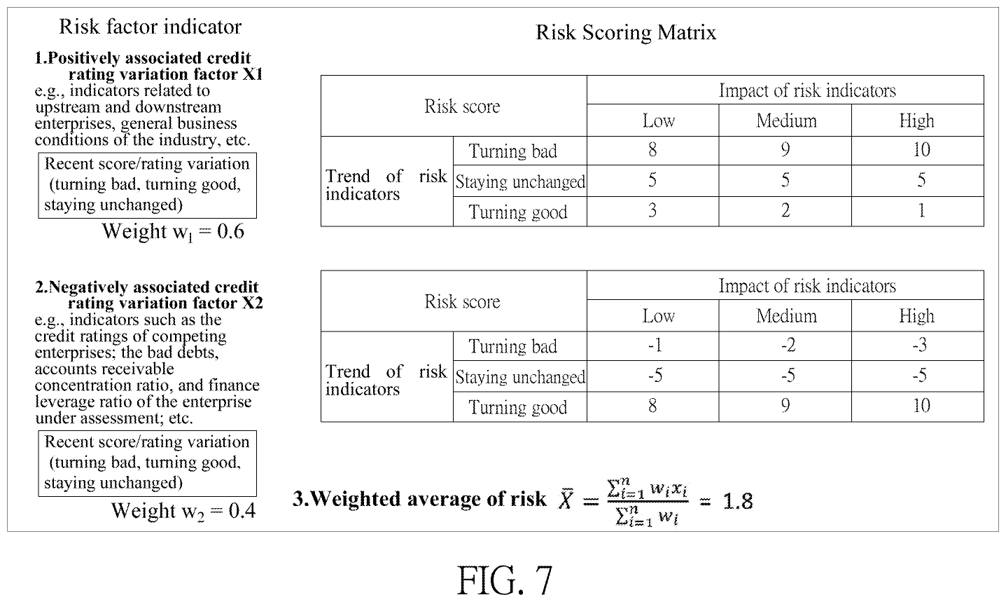

Please refer to FIG. 1 to FIG. 7 for an AI and blockchain-based inter-enterprise credit rating and risk assessment method according to the present invention. The method includes the following steps:

To start with, the credit rating-related data of an enterprise under assessment, of the upstream and downstream enterprises of the enterprise under assessment, and of the competing enterprises of the enterprise under assessment and the business relationships between the foregoing enterprises are established in a blockchain and a database respectively.

The credit rating-related data and the related business relationships are then analyzed with AI to determine the credit rating of the enterprise under assessment.

More specifically, a positively associated credit rating variation factor for the enterprise under assessment is established according to the data in the blockchain and database that involve the upstream and downstream enterprises and according to other positive-impact indicator data as well.

Similarly, a negatively associated credit rating variation factor for the enterprise under assessment is established according to the data in the blockchain and database that involve the competing enterprises and according to other negative-impact indicator data as well.

A risk score of the enterprise under assessment is calculated according to the positively associated credit rating variation factor and the negatively associated credit rating variation factor.

A risk trend curve is plotted from the risk scores of the enterprise under assessment that correspond to different periods respectively.

By analyzing the slope variation of the risk trend curve with a statistical method, the risk rating of the enterprise under assessment in a certain period can be determined.

In the method described above, the credit rating-related data of the enterprise under assessment, of the upstream and downstream enterprises of the enterprise under assessment, and of the competing enterprises of the enterprise under assessment include goodwill-related performances, financial performances, transaction performances, competition performances, credit-related performances, and so forth. The goodwill-related performances of an enterprise include the awards and penalties received by the enterprise, public opinions about the enterprise such as those in the press and in social media, judicial adjudication related to the enterprise, and so on. The financial performances of an enterprise include such financial indicators as the revenue growth rate, after-tax profit growth rate, days payable outstanding, quick ratio, leveraged loan, etc. The transaction performances of an enterprise include the records of transaction between the core units of the enterprise and the upstream and downstream enterprises, a statistical analysis of transaction amounts, and average transaction frequencies, among others. The competition performances of an enterprise include revenues, the number of clients, business scale, and so on. The credit-related performances of an enterprise include credit ratings by a third-party institution, borrowing and repayment records, and so on. The aforementioned data can be obtained through various channels. For example, a piece of data may be, provided by the enterprise to which the data belong, may be open data of the government, may be publicly accessible data on the Internet, or may be publicly accessible data of a third-party institution.

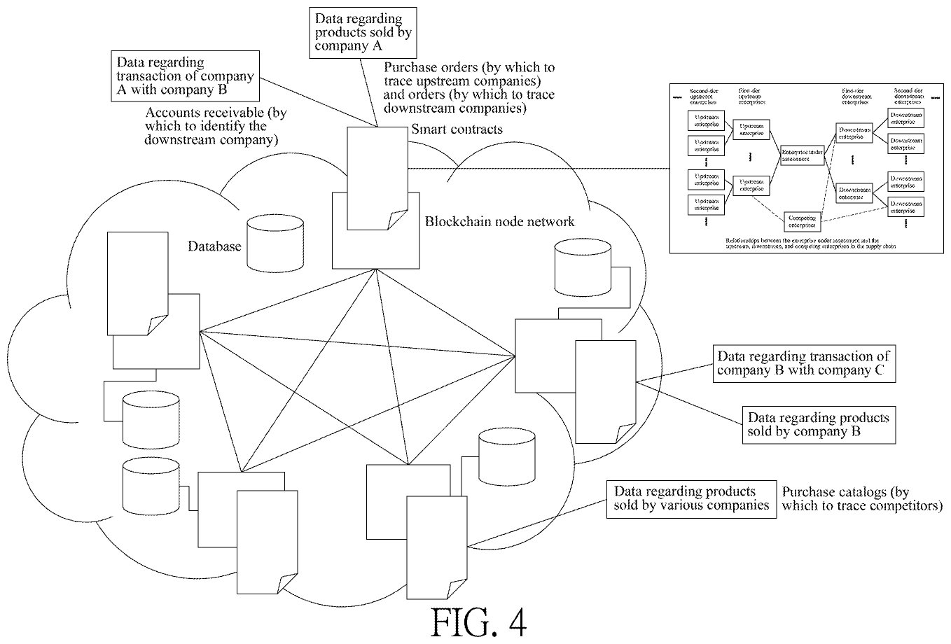

FIG. 4 shows how a blockchain is established between the enterprise under assessment, the upstream and downstream enterprises of the enterprise under assessment, and the competing enterprises of the enterprise under assessment. In the example shown in FIG. 4, there are a piece of transaction data between company A and company B and a piece of transaction data between company B and company C. The transaction data between companies A and B can be linked to the transaction data between companies B and C to establish an upstream/downstream relationship. In addition, the competition relationships between different companies can be established by comparing the publicly accessible product sales data in the purchase catalogs of those companies.

The present invention uses the various credit rating-related data mentioned above (i.e., the multi-dimensional and multi-source data established in the blockchain and the database) to train an AI-based credit rating model, in order for the model to determine, i.e., to make an accurate estimation of, the credit rating of the enterprise under assessment. To assess the enterprise under assessment in a comprehensive, systematic, and objective manner, the method of the invention performs credit rating according to the credit rating-related data not only of the enterprise under assessment itself, but also of the upstream enterprises, downstream enterprises, and competing enterprises of the enterprise under assessment. Moreover, the invention incorporates a statistical method for comparing the credit rating-related data of different periods (e.g., the credit rating-related data of the current period vs those of a previous period). For example, once previous credit ratings of the enterprise under assessment are determined by AI according to the credit rating-related data of multiple previous periods, a trend analysis (e.g., an analysis of month-over-month/year-over-year credit rating variation) is carried out using the statistical method so that the current-period variation, if any, of the risk of the enterprise under assessment can be determined. Thus, by analyzing the credit rating-related data of the enterprise under assessment, of the upstream and downstream enterprises of the enterprise under assessment, and of the competing enterprises of the enterprise under assessment, the invention not only assesses the enterprise under assessment according to more credit rating-related data than those of the enterprise under assessment itself, but also performs a trend analysis based on history data accumulated over time, allowing the current-period variation, if any, of the credit rating risk of the enterprise under assessment to be accurately determined.

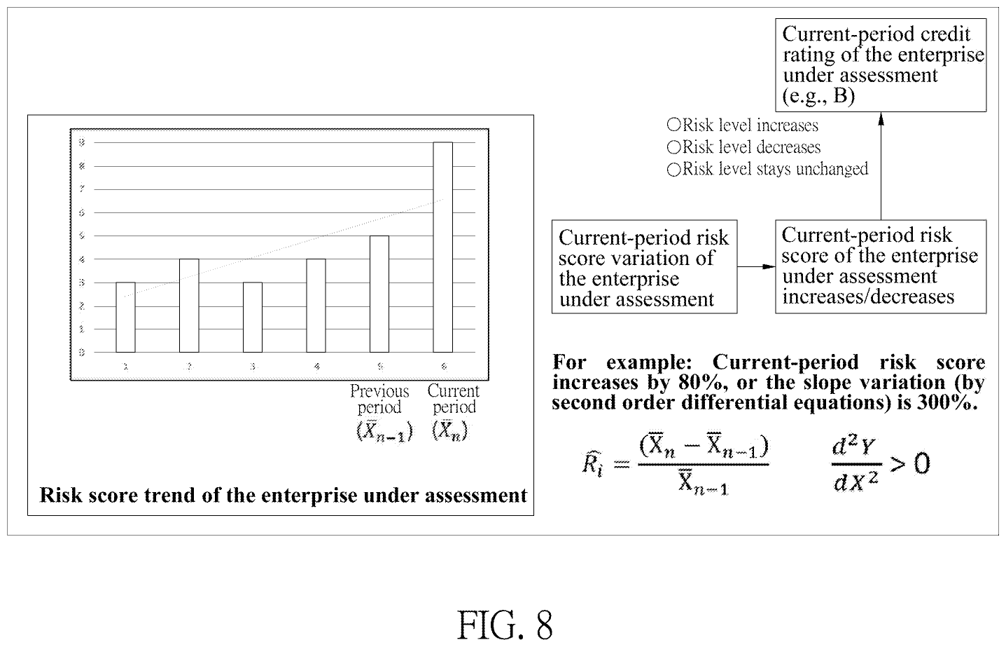

To evaluate the variation of the risk of the enterprise under assessment, a positively associated credit rating variation factor for the enterprise under assessment is established using such indicator data as the credit rating-related data of the upstream and downstream enterprises of the enterprise under assessment and the business conditions of the entire related industry, and a negatively associated credit rating variation factor for the enterprise under assessment is established using such indicator data as the credit rating-related data of the competing enterprises of the enterprise under assessment and the bad debts, accounts receivable concentration ratio, leveraged loan ratio, and so on of the enterprise under assessment. Each credit rating variation factor is used to establish a risk scoring matrix, and a risk score of the enterprise under assessment is calculated according to the matrices. The risk scores of multiple calculation periods can be used to create a risk trend curve as shown in FIG. 8 (in which the endpoints of the bars can be connected by broken lines as well as a curve). The slope variation of the curve (i.e., the second derivative of the curve) indicates whether the risk of the enterprise under assessment is rising, staying the same, or falling.

More specifically, a matrix-based assessment system is established using the positively associated credit rating variation factor and the negatively associated credit rating variation factor. The matrix-based assessment system defines a plurality of indicator values. Each indicator value is assigned a positive or negative value according to the strength of the corresponding positively associated or negatively associated credit rating variation factor, before the matrices are used in conjunction with each other to calculate a risk score. In other words, the matrix-based assessment system can assign different weights to the indicator values according to the strength of the positively associated credit rating variation factor and of the negatively associated credit rating variation factor, in order to determine the risk score through a weighted calculation. The risk trend curve is created with a plurality of risk scores arranged in a chronological order.

The AI-based analysis of the credit rating of the enterprise under assessment plus the construction of the risk trend curve makes it possible to evaluate not only the current-period credit rating but also the risk trend of the enterprise under assessment. For example, while the current-period credit rating of the enterprise under assessment is low, the announcement of a favorable policy may serve as a positive factor that lowers the potential risk of the enterprise under assessment, so more favorable terms and conditions of financing/loan than appropriate for the current-period credit rating may be considered. Or, even though the enterprise under assessment has a normal credit rating, an anticipated marked fluctuation of the exchange rate of the major trading country of the enterprise under assessment may serve as a negative factor that increases the potential risk of the enterprise under assessment; in that case, the terms and conditions of financing/loan should be evaluated prudently. Thus, through credit rating and the risk trend curve, the present invention allows the business trend of the enterprise under assessment to be precisely observed.

The present invention also provides a system constructed according to the method described above. The system includes: a blockchain and database unit for collecting the credit rating-related data of the enterprise under assessment, of the upstream and downstream enterprises of the enterprise under assessment, and of the competing enterprises of the enterprise under assessment; a blockchain and database unit for establishing the business relationships between the enterprise under assessment, the upstream and downstream enterprises, and the competing enterprises; an AI-based credit rating calculation unit for the enterprise under assessment, the upstream and downstream enterprises, and the competing enterprises; and a calculation unit for analyzing the credit and risk of the enterprise under assessment.

What is claimed is:

1. An artificial intelligence (AI) and blockchain-based inter-enterprise credit rating and risk assessment method, comprising the steps of:
establishing credit rating-related data of an enterprise under assessment, of an upstream enterprise and a downstream enterprise of the enterprise under assessment, and of a competing enterprise of the enterprise under assessment and a business relationship between the enterprise under assessment, the upstream enterprise, the downstream enterprise, and the competing enterprise in a blockchain and a database respectively, wherein the credit rating-related data comprise goodwill-related performances, financial performances, transaction performances, competition performances, and credit-related performances; and
analyzing the credit rating-related data and the business relationship with AI to determine a credit rating of the enterprise under assessment, and comparing said credit rating-related data of a current period with said credit rating-related data of a previous period by a statistical method so as to establish a risk trend, thereby allowing a current-period variation of a credit rating risk of the enterprise under assessment to be determined on a chronological basis.

2. The AI and blockchain-based inter-enterprise credit rating and risk assessment method of claim 1, further comprising the steps of:
establishing a positively associated credit rating variation factor for the enterprise under assessment in a predetermined period according to data in the blockchain and the database that involve the upstream enterprise and the downstream enterprise and correspond to the predetermined period and according to other positive-impact indicator data of the predetermined period as well;
establishing a negatively associated credit rating variation factor for the enterprise under assessment in the predetermined period according to data in the blockchain and the database that involve the competing enterprise and correspond to the predetermined period and according to other negative-impact indicator data of the predetermined period as well;
calculating a risk score of the enterprise under assessment for the predetermined period according to the positively associated credit rating variation factor of the predetermined period and the negatively associated credit rating variation factor of the predetermined period;
creating a risk trend curve according to a plurality of said risk scores of the enterprise under assessment that correspond to different periods respectively; and
determining a variation of a risk of the enterprise under assessment according to a slope variation of the risk trend curve.

3. The AI and blockchain-based inter-enterprise credit rating and risk assessment method of claim 2, further comprising the steps of:
establishing a risk scoring matrix of the predetermined period according to the positively associated credit rating variation factor of the predetermined period, and establishing another risk scoring matrix of the predetermined period according to the negatively associated credit rating variation factor of the predetermined period, wherein each said risk scoring matrix defines a plurality of indicator values, and each said indicator value is given a positive or negative value according to a strength of the corresponding one of the positively associated credit rating variation factor and the negatively associated credit rating variation factor;
calculating the risk score of the predetermined period according to the risk scoring matrices; and
creating the risk trend curve according to the plurality of risk scores of the different periods on a chronological basis.

4. The AI and blockchain-based inter-enterprise credit rating and risk assessment method of claim 3, wherein each said indicator value in each of the risk scoring matrices of the predetermined period is weighted by a said positive or negative value according to the strength of the corresponding one of the positively associated credit rating variation factor and the negatively associated credit rating variation factor, in order for the risk score of the predetermined period to be determined by a weighted calculation.

5. A system constructed according to the AI and blockchain-based inter-enterprise credit rating and risk assessment method of claim 1, comprising:
a blockchain and database unit for collecting the credit rating-related data of the enterprise under assessment, of the upstream enterprise, of the downstream enterprise, and of the competing enterprise;
a blockchain and database unit for establishing the business relationship between the enterprise under assessment, the upstream enterprise, the downstream enterprise, and the competing enterprise;
an AI-based credit rating calculation unit for the enterprise under assessment, the upstream enterprise, the downstream enterprise, and the competing enterprise; and
a calculation unit for analyzing a credit and a risk of the enterprise under assessment.
